(19) United States
(12) Patent Application Publication
(10) Pub. No.: US 2017/0155680 A1
(43) Pub. Date: Jun. 1, 2017

(54) INJECT PROBE TRANSMISSION TO DETERMINE NETWORK ADDRESS CONFLICT

(71) Applicant: HEWLETT PACKARD ENTERPRISE DEVELOPMENT LP, Houston, TX (US)

(72) Inventor: Shaun WACKERLY, Roseville, CA (US)

(21) Appl. No.: 15/316,763

(22) PCT Filed: Jun. 30, 2014
(86) PCT No.: PCT/US2014/044784

§ 371 Date: Dec. 6, 2016

(51) Int. Cl. H04L 29/06; H04L 29/12; G06F 17/30; H04L 12/26

(52) U.S. Cl. CPC H04L 63/1466; H04L 43/10; H04L 61/2046; H04L 63/1408; G06F 17/30589

(57) ABSTRACT

Examples of injecting a probe transmission to determine a network address conflict are disclosed. In one example implementation according to aspects of the present disclosure, a computer implemented method may include identifying a conflict in network address information transmitted by an end host within a network by monitoring network address requests within the network. The computer implemented method may then inject a probe transmission to the end host via a controlled network device responsive to identifying the conflict in the network address information transmitted by the end host. Once the probe transmission is injected, the computer implemented method may determine the nature of the conflict in the network address information based on a result of the probe transmission.

### BACKGROUND

Computing devices, such as laptops, desktops, mobile phones, tablets, and the like often utilize resources including services, data, and applications within an electronic communication network. Consequently, networks of these computing devices have grown in size and complexity. These networks may include various infrastructure devices, such as switches, routers, hubs, and the like, which connect to and provide the network for the computing devices.

### BRIEF DESCRIPTION OF THE DRAWINGS

The following detailed description references the drawings, in which:

FIGS. 1A and 1B illustrate a network controller that detects end host movement and network address spoofing within a network by injecting a probe transmission according to examples of the present disclosure;

FIGS. 2A and 2B illustrate a network controller to inject packets within a network for determining the nature of a network addressing conflict according to examples of the present disclosure;

FIG. 3 illustrates a flow diagram of a method for injecting a probe transmission to an end host to determine the nature of a conflict in network address information according to examples of the present disclosure; and

FIG. 4 illustrates a flow diagram of a method for injecting a probe transmission to an end host to determine the nature of a conflict in network address information according to examples of the present disclosure.

### DETAILED DESCRIPTION

A host internet protocol or IPv6 (IP) address may move between ports on a network (such as moving among wireless access points). A host address may also change its media access control (MAC) address (such as a server being replaced or a dynamic host configuration protocol (DHCP) address being re-used). Each of these changes is part of normal network activity on a flexible network. These activities are also difficult to distinguish from attacker behavior, such as where an attacker spoofs a host IP and/or host MAC address.

Previously, networks may have enforced static (or sticky) bindings on a single network device. However, this approach places extensive maintenance and management responsibilities on network administrators. For instance, when a host is decommissioned, the network administrator must reflect the change in each of the network appliances that enforce security. For environments where host addresses change frequently, the network administrator may simply choose not to enforce security, thus causing security problems and leaving the network more susceptible to attack.

Alternatively, networks may have implemented protocol-specific (such as DHCP) packet listening to monitor the specific protocol's perception of the address usage. This approach utilizes protocol-specific knowledge that is embedded within the network appliances so that when new protocols are implemented, the network appliances' firmware needs to be upgraded. This approach is also limited in scope to a single network appliance, so one network appliance could not properly detect whether a host has moved to another network appliance within the network or whether an attack is occurring on another network appliance.

Various implementations are described below by referring to several examples of injecting a probe transmission to determine a network address conflict. For example, a computer implemented method may include identifying a conflict in network address information transmitted by an end host within a network by monitoring network address requests within the network. The computer implemented method may then inject a probe transmission to the end host via a controlled network device responsive to identifying the conflict in the network address information transmitted by the end host. Once the probe transmission is injected, the computer implemented method may determine the nature of the conflict in the network address information based on a result of the probe transmission.

In some implementations, the techniques described can reliably distinguish a host move from a host being spoofed, when that move or spoofing behavior occurs across multiple network devices. Moreover, a software defined network controller is able to detect and mitigate address spoofing more effectively than other single networking devices because it has a view of the network topology that other network devices do not have. These and other advantages will be apparent from the description that follows.

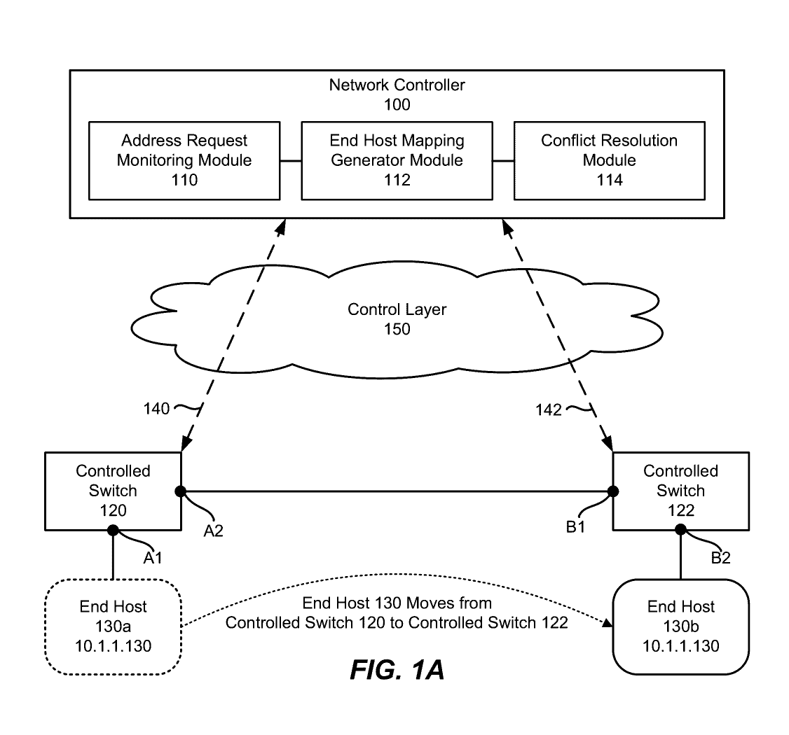

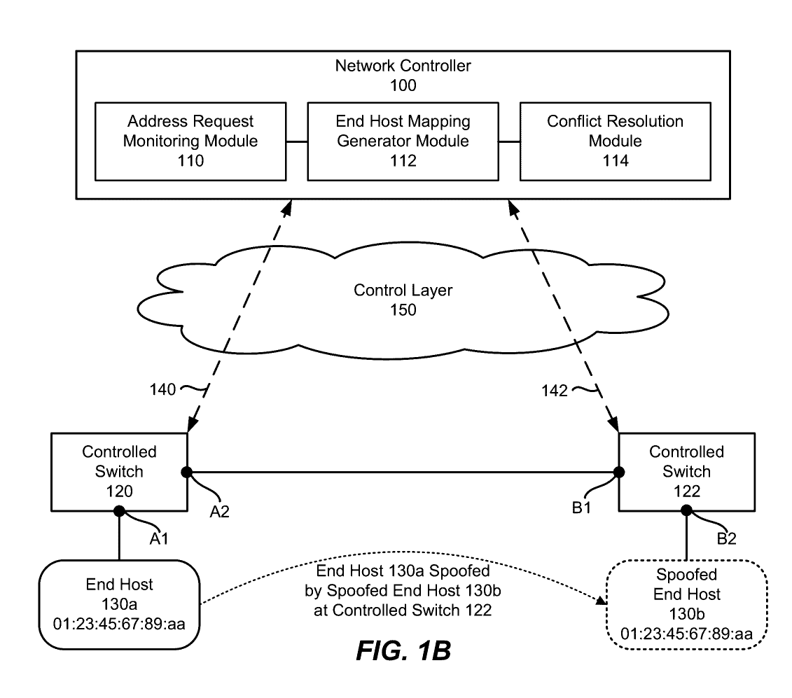

FIGS. 1A and 1B illustrate a network controller 100 that detects end host movement and network address spoofing within a network by injecting a probe transmission according to examples of the present disclosure. FIGS. 1A and 1B include particular components, modules, etc. according to various examples. The network controller 100 may be a computing system to monitor and manage network attached switches. It should be understood that the network controller 100 may include any appropriate type of computing device or computing system, including for example smartphones, tablets, desktops, laptops, workstations, servers, smart monitors, smart televisions, digital signage, scientific instruments, retail point of sale devices, video walls, imaging devices, peripherals, network switches, network routers, network hubs, or the like.

The network controller 100 is communicatively coupled to a plurality of network switches, such as controlled switches 120 and 122. Consequently, the network controller 100 is said to control the controlled switches 120 and 122. The plurality of network switches may each include one or more network ports such as ports A1 and A2 on controlled switch 120 and ports B1 and B2 on controlled switch 122. The end hosts, controlled switches, and network controller are said to form a network. For example, port A1 of controlled switch 120 is connected to end host 130a while port A2 is communicatively coupled to port B1 of controlled switch 122. Port B2 of controlled switch 122 is communicatively coupled to end host 130b. In examples, the network may be homogenous (i.e., made up of the same types and/or configurations of network devices) or heterogeneous (i.e., made up of different types and/or configurations of network devices). These network ports are utilized in communicatively coupling a switch to another networkable device, such as an end host device, another switch, a router, or another network device. These communicative couplings are referred to as links within the network.

The network represents generally hardware components and computers interconnected by communications channels that allow sharing of resources and information. The network may include one or more of a cable, wireless, fiber optic, or remote connection via a telecommunication link, an infrared link, a radio frequency link, or any other connectors or systems that provide electronic communication. The network may include, at least in part, an Intranet, the internet, or a combination of both. In another example, the network may be a software defined network and/or a virtualized network. The network may also include intermediate proxies, routers, switches, load balancers, and the like. The paths followed by network between the various components such as network controller 100, controlled switches 120 and 122 and end host 130a,b as depicted in FIGS. 1A and 1B, represent the logical communication paths between these devices, not necessarily the physical paths between the devices. It should be understood that additional network devices may be included in the network even though they are not shown in FIGS. 1A and 1B.

FIG. 1A illustrates an end host 130a,b moving within the network, which is depicted by the dotted lines. For example, end host 130a,b is initially connected to controlled switch 120 at port A1. This position is designated as end host 130a. End host 130a may have an associated networking address such as an internet protocol (IP) address, media access control (MAC) address, or another suitable networking address. In the example illustrated in FIG. 1A, end host 130a has an IP address of 10.1.1.130. When the end host 130a moves to be communicatively coupled to controlled switch 122 at port B2, the end host 130a becomes end host 130b. It should be understood that moving within the network may indicate that the end host physically moved within the network or is connected to a different controlled network device within the network.

Additionally, each (or some) of the plurality of controlled switches 120 and 122 may include additional ports (not shown) for connecting the controlled switches to the network controller 100. These links are illustrated by the dashed lines 140 and 142, across which network traffic may be copied or transmitted from the controlled switches to the network controller 100 through a control layer 150 (or similar transmission layer) of the network. When a controlled switch, such as the controlled switches 120 and 122 receives network traffic (e.g., data packets), each of the controlled switches 120 and 122 transmit a copy of that packet to the network controller 100. However, in other examples, packets from a certain protocol (e.g., ARP or DHCP) or the first packet of unique transmission flows from a specific host may be copied or sent to the network controller 100. This enables the network controller 100 to listen for packets transmitted within the network.

In an example, the network controller 100 includes an address request monitoring module 110, an end host mapping generator module 112, and a conflict resolution module 114. The network controller 100 may also include various additional hardware components (not shown), including processing resources, memory resources, networking resources, storage resources, databases, and the like.

The address request monitoring module 110 of the network controller 100 monitors network address requests within the network to identify any conflicts in address information transmitted by end hosts within the network. A conflict occurs when the network address information (also known as link layer or control plane information) for a specific address changes compared to known link information for that end host. For example, a conflict may occur when a MAC address of a specific IP changes and/or when the port associated with a MAC address changes. Both the port and MAC address should be considered part of the “network address” which may have a conflict. The link information may be stored in a database or generated, for example, by the end host mapping generator module 112. The link information indicates across which links network traffic travels from a particular end host. By knowing this link information, the address request monitoring module 110 can compare the known link information to network address request information received from end hosts to determine whether a conflict in address information exists.

In examples, the conflict in the network address information may be identified by referencing an end host mapping dataset, which is generated by the end host mapping generator module 112. However, in other examples, the end host mapping dataset may be previously known. The address request monitoring module 110 accesses the end host mapping dataset (once generated), to determine whether a conflict has occurred based on the network address information received from the end hosts as compared to the information contained in the end host mapping dataset.

In particular, the end host mapping generator module 112 generates an end host mapping dataset based on the monitored network address requests. For example, when the end host 130a transmits network address requests, the requests (or information relating to the requests) are copied or otherwise transmitted to the network controller 100 through the control layer 150 of the network via the links 140 and/or 142 from the controlled switches 120 and 122 respectively. The information concerning the network address requests is used by the end host mapping generator 112 to generate an end host mapping dataset representative of the various end hosts and to which controlled switches each end host is connected. In the example shown in FIG. 1A, the end host mapping dataset may reflect that end host 130a is connected to controlled switch 120 at port A1.

A conflict is then identified, in the example shown, as a result of end host 130a moving to end host 130b. In this example, the address request monitoring module 110 receives network address information originating at end host 130b indicating that end host 130b is connected to controlled switch 122 at port B2. However, because the end host mapping dataset reflects that end host 130a was previously connected to controlled switch 120 at port A1, the address request monitoring module 110 identifies a conflict in the network address information.

Once a conflict in the network address information is identified by the address request monitoring module 110 (i.e., once the end host 130a moves to end host 130b), the conflict resolution module 114 determines, using the end host mapping dataset generated by the end host mapping generator module 112, the nature of the conflict in the address information based on a result of a probe transmission injected to the end host via a controlled switch. For example, when the address request monitoring module 110 identifies a conflict in the network address information, the conflict resolution module 114 determines whether the end host moved within the network or whether another network device is attempting to spoof the end host by pretending to be that end host and using the end host's network address information.

In the example shown in FIGS. 1A and 1B, the address request monitoring module 110 monitors network address requests of end host 130a (as well as other end hosts within the network). The copies of, or information relating to, the data packets and related address requests are transmitted to the network controller 100 through the control plane 150 of the network, as illustrated by paths 140 and 142 via the controlled switches 120 and/or 122. Once the end host 130a moves to end host 130b in FIG. 1A, the address request monitor module 110 identifies a conflict in the network address information as compared to the end host mapping dataset. In this case, the conflict exists as a result of end host 130b's connection point (i.e., port B2 of controlled switch 122) not matching the previously known connection point (i.e., port A1 of controlled switch 120) for end host 130a.

Similarly, in FIG. 1B, the address request monitor module 110 identifies a conflict in the MAC address information when spoofed end host 130b transmits network traffic in FIG. 1B. In this case, the conflict exists because the conflict exists as a result of end host 130b's connection point (i.e., port B2 of controlled switch 122) not matching the previously known connection point (i.e., port A1 of controlled switch 120) for end host 130a.

To resolve the conflict in network address information, the conflict resolution module 114 injects a probe transmission through the control layer 150 to the end host 130a via a controlled network device, such as controlled switch 120. Specifically, the probe transmission is directed to the network address for the end host stored in the end host mapping dataset. In examples, the network controller 100 may not be a network device that is visible to the end host; therefore, the network controller 100 injects the probe transmission via a network device that the network controller 100 controls, such as controlled switch 120. This may be the case, for example, in software defined networks. However, in other examples, if the network controller 100 may communicate directly with the end hosts, it may directly inject the communication.

In FIG. 1A, the probe transmission is transmitted to end host 130a via controlled switch 120. The conflict resolution module 114 of the network controller 100 waits for a result to the injected probe transmission, which may be a response transmission received via the controlled network device (e.g., controlled switches 120). In examples, waiting for a result to the injected probe transmission may occur for a predetermined period of time, which may be set by an administrator and may be customized. Continuing with the example in FIG. 1A, the probe transmission is sent by controlled switch 120 to end host 130a. However, because end host 130a moved to end host 130b, end host 130a cannot, and therefore does not, respond to the injected probe transmission. After waiting the predetermined period of time without receiving a response to the probe transmission, the conflict resolution module 114 indicates to the network controller 100 that the end host 130a moved because no response was received. In other examples, rather than waiting for a particular response message, waiting for a response may include waiting for any network traffic transmitted from the end host (such as another, possibly unrelated, network transmission from the end host). In such an example, the conflict resolution module 114 observes network traffic from the end host's prior location, but that traffic is not in response to the injected probe transmission. In such a case, the conflict resolution module 114 utilizes that information to identify the host as still being at the prior location (and thus determine that the conflict was spoofed traffic). The end host mapping generator 112 may update the end host mapping dataset with the network address and link information for end host 130b in an example. In another example, the end host mapping generator 112 may remove the entry for the end host 130a and allow the address request monitoring module 110 to identify a “new” end host 130b.

In FIG. 1B, the probe transmission in transmitted to end host 130a via controlled switch 120. The conflict resolution module 114 of the network controller 100 waits for a result to the injected probe transmission, which is received via controlled switch 120. When the response to the probe transmission is received by the conflict resolution module 114, the conflict resolution module 114 indicates to network controller 100 that spoofed end host 130b is a spoofed end host, not a moved end host. In this case, spoofed end host 130b is attempting to gain network access by presenting itself to be end host 130a, as indicated by the fact that the two end hosts share the same MAC address (01:23:45:67:89:aa).

The conflict resolution module 114 may then alert a network administrator of the detected spoofing, which may be indicative of a network security problem, or the conflict resolution module 114 may take an appropriate security action such as logging the spoofing event, blocking the detected spoofing end host, monitoring communications to and/or from the spoofed end host, and combinations thereof.

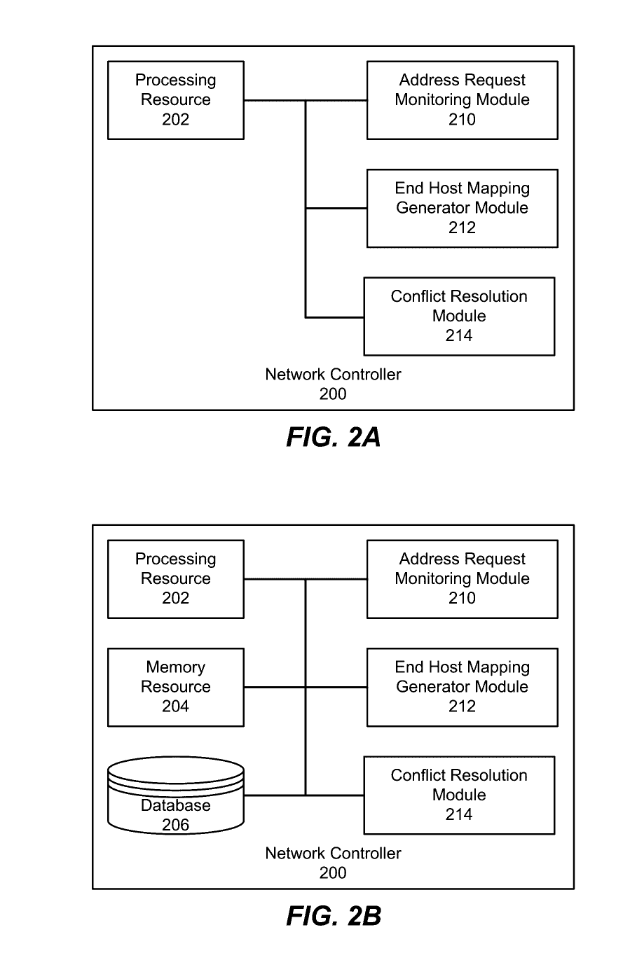

FIGS. 2A and 2B illustrate a network controller 200 to inject packets within a network for determining the nature of a network addressing conflict according to examples of the present disclosure. FIGS. 2A and 2B include particular components, modules, etc. according to various examples. However, in different implementations, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

The network controller 200 may be a computing system to monitor and manage network attached switches. It should be understood that the network controller 200 may include any appropriate type of computing device or computing system, including for example smartphones, tablets, desktops, laptops, workstations, servers, smart monitors, smart televisions, digital signage, scientific instruments, retail point of sale devices, video walls, imaging devices, peripherals, network switches, network routers, network hubs, or the like. Additionally, the network controller 200 may be communicatively coupled to other networking devices, such as switches, hubs, routers, and combinations thereof.

The network controller 200 may include a processing resource 202 that represents generally any suitable type or form of processing unit or units capable of processing data or interpreting and executing instructions. The instructions may be stored on a non-transitory tangible computer-readable storage medium, such as memory resource 204, or on a separate device (not shown), or on any other type of volatile or non-volatile memory that stores instructions to cause a programmable processor to perform the techniques described herein. Alternatively or additionally, the network controller 200 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory.

In an example, the network controller 200 also includes an address request monitoring module 210, an end host mapping generator module 212, and a conflict resolution module 214. The network controller 200 may also include various additional hardware components, including processing resources, memory resources (such as memory resource 204), networking resources, storage resources, data stores (such as database 206), and the like.

The address request monitoring module 210 of the network controller 200 monitors network address requests within the network to identify any conflicts in address information transmitted by end hosts within the network. A conflict occurs when the network address information (also known as link layer or control plane information) for a specific address changes compared to known link information for that end host. The link information may be stored in a database or generated, for example, by the end host mapping generator module 212. The link information indicates across which links network traffic travels from a particular end host. By knowing this link information, the address request monitoring module 210 can compare the known link information to network address request information received from end hosts to determine whether a conflict in address information exists.

In examples, the conflict in the network address information may be identified by referencing an end host mapping dataset, which is generated by the end host mapping generator module 212. However, in other examples, the end host mapping dataset may be previously known and stored, for example, in database 206. The address request monitoring module 210 accesses the end host mapping dataset (once generated), to determine whether a conflict has occurred based on the network address information received from the end hosts as compared to the information contained in the end host mapping dataset. In particular, the end host mapping generator module 212 generates an end host mapping dataset based on the monitored network address requests. The information concerning the network address requests is used by the end host mapping generator 212 to generate an end host mapping dataset representative of the various end hosts and to which controlled switches each end host is connected.

Once a conflict in the network address information is identified by the address request monitoring module 210, the conflict resolution module 214 determines, using the end host mapping dataset generated by the end host mapping generator module 212, the nature of the conflict in the address information based on a result of a probe transmission injected to the end host via a controlled switch. For example, when the address request monitoring module 210 identifies a conflict in the network address information, the conflict resolution module 214 determines whether the end host moved within the network or whether another network device is attempting to spoof the end host by pretending to be that end host and using the end host's network address information.

To resolve the conflict in network address information, the conflict resolution module 214 injects a probe transmission through the control layer to the end host via a controlled network device. Specifically, the probe transmission is directed to the network address for the end host stored in the end host mapping dataset. In examples, the network controller may not be a network device that is visible to the end host; therefore, the network controller 200 injects the probe transmission via a network device that the network controller 200 controls. This may be the case, for example, in software defined networks. However, in other examples, if the network controller 200 may communicate directly with the end hosts, it may directly inject the communication.

The conflict resolution module 214 of the network controller 200 waits for a result to the injected probe transmission, which may be a response transmission received via the controlled network device. In examples, waiting for a result to the injected probe transmission may occur for a predetermined period of time, which may be set by an administrator and may be customized. Upon not receiving a response transmission within the predetermined period of time, the conflict resolution module 214 may cause the end host mapping dataset to be updated to reflect that the end host moved within the network.

However, if the response transmission is received, it is determined that a spoofing end host is attempting to communicate within the network. The conflict resolution module 214 may then alert a network administrator of the detected spoofing, which may be indicative of a network security problem, or the conflict resolution module 214 may take an appropriate security action such as logging the spoofing event, blocking the detected spoofing end host, monitoring communications to and/or from the spoofed end host, and combinations thereof.

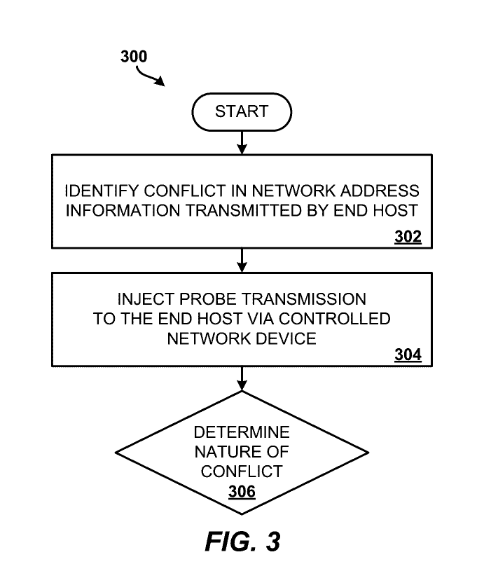

FIG. 3 illustrates a flow diagram of a method 300 for injecting a probe transmission to an end host to determine the nature of a conflict in network address information according to examples of the present disclosure. The method 300 may be executed by a computing system or a computing device such as network controller 100 of FIGS. 1A and 1B or network controller 200 of FIGS. 2A and 2B or may be stored as instructions on a non-transitory computer-readable storage medium that, when executed by a processor, cause the processor to perform the method 300. In one example, method 300 may include: identifying a conflict in network address information transmitted by an end host (block 302); injecting a probe transmission to the end host (block 304); and determining the nature of the conflict in the network address information (block 306).

At block 302, the method 300 includes identifying a conflict in network address information transmitted by an end host. For example, a computing system (e.g., network controller 100 of FIGS. 1A and 1B or network controller 200 of FIGS. 2A and 2B) identifies a conflict in network address information transmitted by an end host within a network by monitoring network address requests within the network. The method 300 continues to block 304.

At block 304, the method 300 includes injecting a probe transmission to the end host. For example, a computing system (e.g., network controller 100 of FIGS. 1A and 1B or network controller 200 of FIGS. 2A and 2B) injects a probe transmission to the end host via a controlled network device. The probe transmission may be injected responsive to identifying the conflict in the network address information transmitted by the end host at block 302. The method 300 continues to block 306.

At block 306, the method 300 includes determining the nature of the conflict in the network address information. For example, a computing system (e.g., network controller 100 of FIGS. 1A and 1B or network controller 200 of FIGS. 2A and 2B) determines the nature of the conflict in the network address information based on a result of the probe transmission. In determining the nature of the conflict in the network address information, the computing system waits for a result to the injected probe transmission, which may be a response transmission received via the controlled network device (e.g., controlled switches 120 and/or 122 of FIGS. 1A and 1B). In examples, waiting for a result to the injected probe transmission may occur for a predetermined period of time, which may be set by an administrator and may be customized.

If no result or response is received within the predetermined period of time in response to the injected probe transmission, it is determined that the end host moved within the network. Moving within the network may indicate that the end host physically moved within the network or is connected to a different controlled network device within the network. If, however, a result or response is received by the computing system within the predetermined time it is determined that the end host was spoofed by another end host.

Additional processes also may be included, and it should be understood that the processes depicted in FIG. 3 represent illustrations, and that other processes may be added or existing processes may be removed, modified, or rearranged without departing from the scope and spirit of the present disclosure.

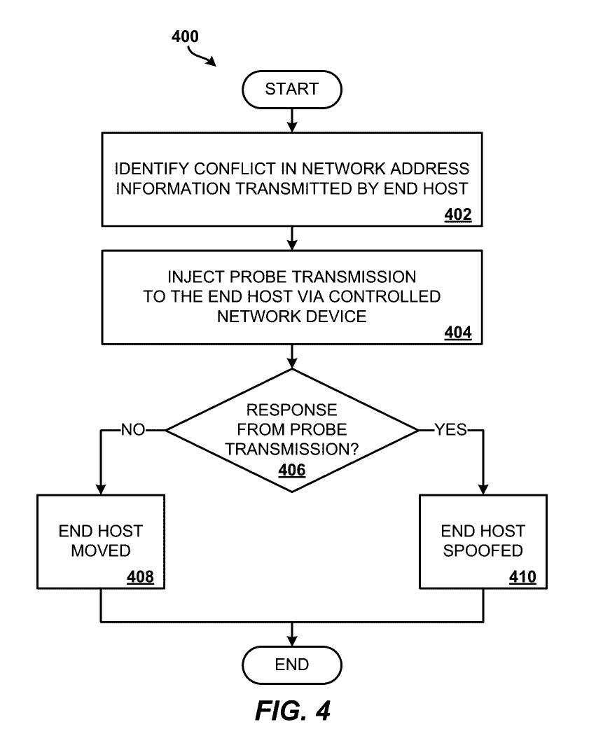

FIG. 4 illustrates a flow diagram of a method 400 for injecting a probe transmission to an end host to determine the nature of a conflict in network address information according to examples of the present disclosure. The method 400 may be executed by a computing system or a computing device such as network controller 100 of FIG. 1 or network controller 200 of FIGS. 2A and 2B or may be stored as instructions on a non-transitory computer-readable storage medium that, when executed by a processor, cause the processor to perform the method 400. In one example, method 400 may include: identifying a conflict in network address information transmitted by an end host (block 402); includes injecting a probe transmission to the end host (block 404); determining the nature of the conflict in the network address information (block 406), which may indicate that the end host has moved (block 408) or has been spoofed (block 408).

At block 402, the method 400 includes identifying a conflict in network address information transmitted by an end host. For example, a computing system (e.g., network controller 100 of FIGS. 1A and 1B or network controller 200 of FIGS. 2A and 2B) identifies a conflict in network address information transmitted by an end host within a network by monitoring network address requests within the network. The method 400 continues to block 404.

At block 404, the method 400 includes injecting a probe transmission to the end host. For example, a computing system (e.g., network controller 100 of FIGS. 1A and 1B or network controller 200 of FIGS. 2A and 2B) injects a probe transmission to the end host device via a controlled network device (e.g., controlled switches 120 and/or 122 of FIGS. 1A and 1B). The probe transmission may be injected responsive to identifying the conflict in the network address information transmitted by the end host at block 402. The method 400 continues to block 406.

At block 406, the method 400 includes determining the nature of the conflict in the network address information. For example, a computing system (e.g., network controller 100 of FIGS. 1A and 1B or network controller 200 of FIGS. 2A and 2B) determines the nature of the conflict in the network address information based on a result of the probe transmission. In determining the nature of the conflict in the network address information, the computing system waits for a result to the injected probe transmission, which may be a response transmission received via the controlled network device (e.g., controlled switches 120 and/or 122 of FIGS. 1A and 1B). In examples, waiting for a result to the injected probe transmission may occur for a predetermined period of time, which may be set by an administrator and may be customized.

If no result or response is received within the predetermined period of time in response to the injected probe transmission, it is determined that the end host moved within the network. Moving within the network may indicate that the end host physically moved within the network or is connected to a different controlled network device within the network (block 408). If, however, a result or response is received by the computing system within the predetermined time it is determined that the end host was spoofed by another end host (block 410).

Additional processes also may be included, and it should be understood that the processes depicted in FIG. 4 represent illustrations, and that other processes may be added or existing processes may be removed, modified, or rearranged without departing from the scope and spirit of the present disclosure.

It should be emphasized that the above-described examples are merely possible examples of implementations and set forth for a clear understanding of the present disclosure. Many variations and modifications may be made to the above-described examples without departing substantially from the spirit and principles of the present disclosure. Further, the scope of the present disclosure is intended to cover any and all appropriate combinations and sub-combinations of all elements, features, and aspects discussed above. All such appropriate modifications and variations are intended to be included within the scope of the present disclosure, and all possible claims to individual aspects or combinations of elements or steps are intended to be supported by the present disclosure.

What is claimed is:

1. A method comprising:
identifying, by a computing system, a conflict in network address information transmitted by an end host within a network by monitoring network address requests within the network;
responsive to identifying the conflict in the network address information transmitted by the end host, injecting, by the computing system, a probe transmission to the end host via a controlled network device; and
determining, by the computing system, the nature of the conflict in the network address information based on a result of the probe transmission.

2. The method of claim 1, wherein determining the nature of the conflict in the network address information further comprises:
determining, by the computing system, that the end host moved within the network when no response from the end host is received by the computing system responsive to the probe transmission.

3. The method of claim 1, wherein determining the nature of the conflict in the network address information further comprises:
determining, by the computing system, that the end host was spoofed when a response from the end host is received by the computing system responsive to the probe transmission.

4. The method of claim 3, wherein the response from the end host is received via the controlled network device.

5. The method of claim 1, further comprising:
generating, by the computing system, an end host mapping dataset based on the monitored network address requests,
wherein identifying the conflict in the network address information transmitted by the end host is based on the end host mapping dataset.

6. A network controller comprising:
a processing resource;
an address request monitor module executable by the processing resource to identify a conflict in network address information transmitted by an end host within a network by monitoring network address requests within the network;
an end host mapping generator module executable by the processing resource to generate an end host mapping dataset based on the monitored network address requests; and
a conflict resolution module executable by the processing resource to determine, using the end host mapping dataset, the nature of the conflict in the network address information based on a result of a probe transmission injected to the end host via a controlled network device.

7. The network controller of claim 6, further comprising:
a data store to store the end host mapping dataset.

8. The network controller of claim 6, wherein the result of the probe transmission is a response transmission sent by the end host via the controlled network device.

9. The network controller of claim 8, wherein the conflict resolution module waits a predetermined amount of time for the response transmission sent by the end host.

10. The network controller of claim 6, wherein determining the nature of the conflict in the network address information further comprises:
determining, by the computing system, that the end host moved within the network when no response from the end host is received by the computing system responsive to the probe transmission.

11. The network controller of claim 6, wherein determining the nature of the conflict in the network address information further comprises:
determining, by the computing system, that the end host was spoofed when a response from the end host is received by the computing system responsive to the probe transmission.

12. A non-transitory computer-readable storage medium storing instructions that, when executed by a processing resource, cause the processing resource to:
identify a conflict in network address information transmitted by an end host within a network by monitoring network address requests within the network;
inject a probe transmission to the end host device via a controlled network device responsive to identifying the conflict in the network address information transmitted by the end host; and
determine the nature of the conflict in the network address information based on a result of the probe transmission,
wherein it is determined that the end host moved within the network when no response from the end host is received during a predetermined time period by the computing system responsive to the probe transmission, and
wherein it is determined that the end host was spoofed by another end host when a response from the end host is received during the predetermined time period by the computing system responsive to the probe transmission.

13. The non-transitory computer-readable storage medium of claim 12, wherein the predetermined time period is customizable.

14. The non-transitory computer-readable storage medium of claim 12, further comprising instructions to cause the processing resource to:
generate an end host mapping dataset based on the monitored network address requests,
wherein identifying the conflict in the network address information transmitted by the end host is based on the end host mapping dataset.

15. The non-transitory computer-readable storage medium of claim 12, further comprising instructions to cause the processing resource to:
implement a security action responsive to determining that the end host was spoofed by another end host.
